(19) United States
(12) Patent Application Publication
(10) Pub. No.: US 2026/0212845 A1
(43) Pub. Date: Jul. 23, 2026

(54) STRING-DRAWN HI-HAT

(71) Applicant: Music Will, Inc., Covina, CA (US)

(72) Inventor: David Wish, Montclair, NJ (US)

(21) Appl. No.: 19/454,756

(22) Filed: Jan. 21, 2026

Related U.S. Application Data
(60) Provisional application No. 63/747,685, filed on Jan. 21, 2025.

(51) Int. Cl. G10D 13/065; G10D 13/11

(52) U.S. Cl. CPC G10D 13/065; G10D 13/11

(57) ABSTRACT

The present disclosure relates to a string-drawn hi-hat for a drum set. The string-drawn hi-hat includes a cymbal assembly comprising an upper cymbal and a lower cymbal, the upper cymbal biased away from the lower cymbal; a foot pedal configured to rest on a support surface; and an actuator string extending between the cymbal assembly and the foot pedal; wherein the foot pedal is operable to pull the actuator string towards the support surface to hit the upper cymbal against the lower cymbal. The string-drawn hi-hat is mounted to the drum set using a cymbal mount optionally comprising pivot hinges that enable the three-dimensional movement of the string-drawn hi-hat relative to the drum set.

### CROSS-REFERENCE TO RELATED APPLICATIONS

This Application claims the benefit of and priority to U.S. Provisional Application No. 63/747,685 filed on Jan. 21, 2025, the contents of which are hereby incorporated by reference.

### FIELD OF INVENTION

This disclosure generally relates to musical instruments. More specifically, this disclosure relates to a string-drawn hi-hat.

### BACKGROUND

Hi-hats are a core component of modern drum kits, serving to add a rhythmic pulse, musical accents, and other dynamics to a drumbeat. Traditional hi-hats commonly comprise a pair of opposing cymbals biased away from each other on a floor stand and are operable by a foot pedal that actuates a mechanical linkage which brings one of the cymbals towards the other to create a clanging sound.

However, typical hi-hat stands are large, heavy, require a few square feet of floor space to accommodate their base (usually a tripod), and can be awkward to transport. Additionally, hi-hats utilizing a floor can only be played in a cross-sticking position as opposed to open-position sticking. An open-sticking position for a right-handed player, for example, is only possible if the right foot can operate the kick pedal and the left foot can operate the hi-hat and, at the same time, the right hand can strike the hi-hats while the left hand strikes the snare. Indeed, it is impossible to reposition a traditional hi-hat floor stand in such a way that facilitates open-position sticking.

It would be advantageous to create a hi-hat assembly that addressed the above concerns while giving musicians full access to the instrument's capabilities. Accordingly, a need exits for a convenient and effective way to adjust and transport a hi-hat.

### SUMMARY

To address the above and other deficiencies, the present disclosure contemplates a string-drawn hi-hat. It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following detailed description.

Disclosed is a hi-hat for a drum set, the hi-hat comprising a cymbal assembly comprising an upper cymbal and a lower cymbal, the upper cymbal biased away from the lower cymbal; a foot pedal configured to rest on a support surface; and an actuator string extending between the cymbal assembly and the foot pedal; wherein the foot pedal is operable to pull the actuation string towards the support surface to hit the upper cymbal against the lower cymbal.

Also disclosed is a drum set comprising a drum assembly; a hi-hat comprising: a cymbal assembly comprising an upper cymbal and a lower cymbal, the upper cymbal biased away from the lower cymbal; a foot pedal configured to rest on a support surface; an actuator string extending between the cymbal assembly and the foot pedal; and a cymbal mount coupled to the drum assembly and supporting the cymbal assembly above the support surface; wherein the foot pedal is operable to pull the actuation string towards the support surface to hit the upper cymbal against the lower cymbal.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

Certain embodiments are shown in the drawings. However, it is understood that the present disclosure is not limited to the arrangements and instrumentality showing in the attached drawings. Corresponding features and components throughout the drawings may be designated by matching reference characters for the sake of consistency and clarity.

FIG. 1A is a front perspective view of a drum set comprising a string-drawn hi-hat, in accordance with one example aspect of the present disclosure, wherein a mounting arm of the string-drawn hi-hat is in a shortened configuration.

FIG. 1B is a top view of the drum set of FIG. 1A.

FIG. 2A is a front perspective view of the drum set of FIG. 1A, wherein the mounting arm is in a lengthened configuration.

FIG. 2B is a top view of the drum set of FIG. 2A.

FIG. 3A is a front perspective view of the drum set comprising the string-drawn hi-hat, in accordance with another example aspect of the present disclosure.

FIG. 3B is a top view of the drum set of FIG. 3A.

FIG. 4 is a perspective view of a foot pedal of the string-drawn hi-hat, in accordance with an example aspect of the present disclosure.

FIG. 5A is a top view of the foot pedal of FIG. 4.

FIG. 5B is a bottom view of the foot pedal of FIG. 4.

FIG. 6A is a left-side view of the foot pedal of FIG. 4.

FIG. 6B is a right-side view of the foot pedal of FIG. 4.

FIG. 7A is a front view of the foot pedal of FIG. 4.

FIG. 7B is a rear view of the foot pedal of FIG. 4.

FIG. 8 is a perspective view of a cymbal assembly of the string-drawn hi-hat, in accordance with an example aspect of the present disclosure.

FIG. 9 is an exploded view of the cymbal assembly of FIG. 8.

FIG. 10 is a front view of the cymbal assembly of FIG. 8.

FIG. 11 is a rear view of the cymbal assembly of FIG. 8.

FIG. 12 is a left-side view of the cymbal assembly of FIG. 8.

FIG. 13 is a right-side view of the cymbal assembly of FIG. 8.

FIG. 14 is a top view of the cymbal assembly of FIG. 8.

FIG. 15 is a bottom view of the cymbal assembly of FIG. 8.

FIG. 16 is a perspective view of the cymbal assembly of the string-drawn hi-hat, in accordance with another example aspect of the present disclosure.

FIG. 17 is an exploded view of a housing of the cymbal assembly of FIG. 16.

FIG. 18 is a cross-sectional view of the housing taken along line 18-18 in FIG. 16, illustrating an expanded position of a spring within the housing.

FIG. 19 is a cross-sectional view of the housing taken along line 18-18 in FIG. 16, illustrating a compressed position of the spring within the housing.

FIG. 20 is a front view of the cymbal assembly of FIG. 16.

FIG. 21 is a rear view of the cymbal assembly of FIG. 16.

FIG. 22 is a right-side view of the cymbal assembly of FIG. 16.

FIG. 23 is a left-side view of the cymbal assembly of FIG. 16.

FIG. 24 is a top view of the cymbal assembly of FIG. 16.

FIG. 25 is a bottom view of the cymbal assembly of FIG. 16.

### DETAILED DESCRIPTION

The present disclosure can be understood more readily by reference to the following detailed description, examples, drawings, and claims, and the previous and following descriptions. However, before the present devices, systems, and/or methods are disclosed and described, it is to be understood that this disclosure is not limited to the specific devices, systems, and/or methods disclosed unless otherwise specified, and, as such, can vary. It is also to be understood that the terminology used herein is for the purpose of describing particular aspects of the present disclosure only and is not intended to be limiting.

The following description is provided as an enabling teaching of the devices, systems, and/or methods of the present disclosure in their best, currently known aspect. To this end, those skilled in the relevant art will recognize and appreciate that many changes can be made to the various aspects of the present devices, systems, and/or methods described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to “an element” can include two or more such elements unless the context clearly indicates otherwise.

Ranges can be expressed herein as from “about” one particular value and/or to “about” another particular value. When such a range is expressed, another aspect includes from the one particular value and/or to the other particular value. Similarly, when values are expressed as approximations by use of the antecedent “about,” it will be understood that the particular value forms another aspect. It will be further understood that the endpoints of each of the ranges are significant both in relation to the other endpoint and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes, and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for one or more particular aspects or that one or more particular aspects necessarily include logic for deciding, with or without user input or prompting, whether these features, elements, and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a string-drawn hi-hat for a drum set and associated methods, systems, devices, and various apparatus. Example aspects of the string-drawn hi-hat can comprise a cymbal assembly, a foot pedal, and an actuator string operatively connecting the cymbal assembly to the foot pedal. It would be understood by one of skill in the art that the string-drawn hi-hat disclosed herein is described in but a few exemplary embodiments among many. No particular terminology or description should be considered limiting on the disclosure or the scope of any claims issuing therefrom.

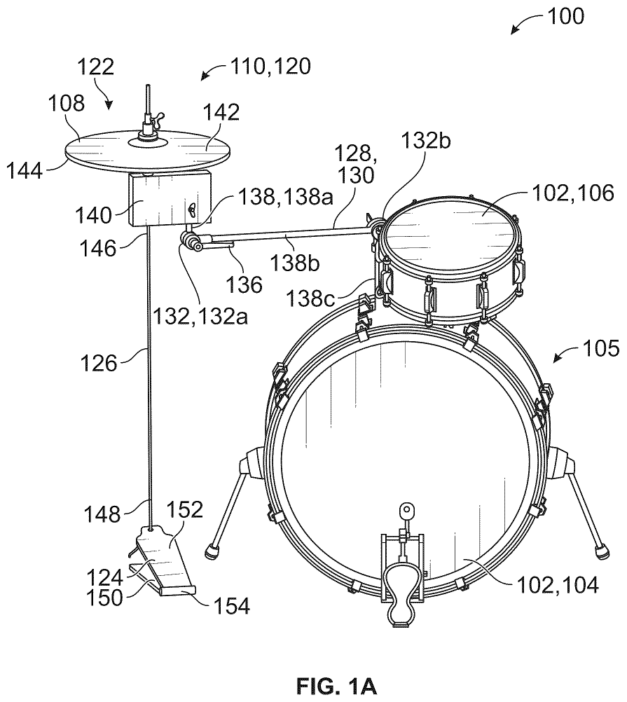

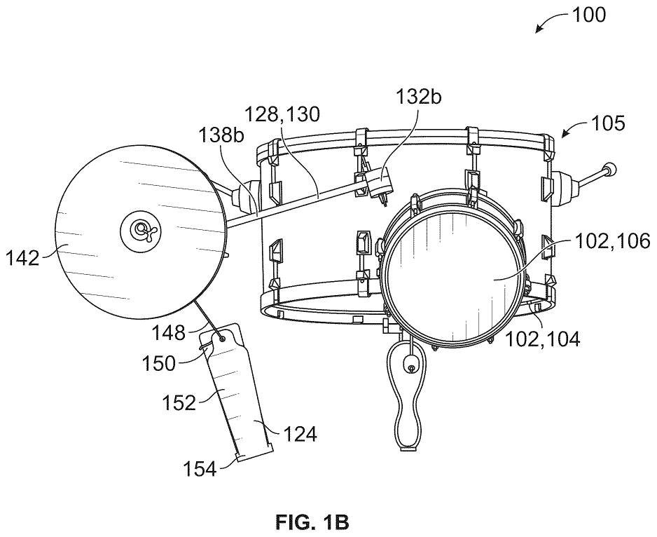

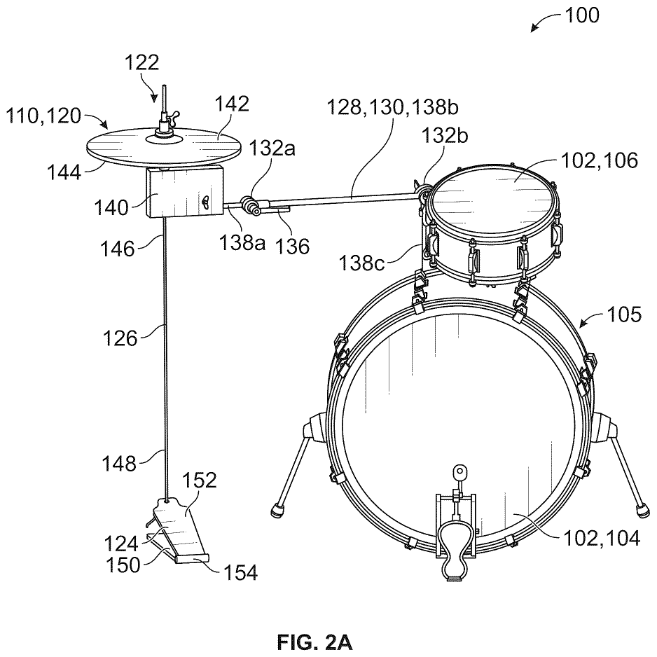

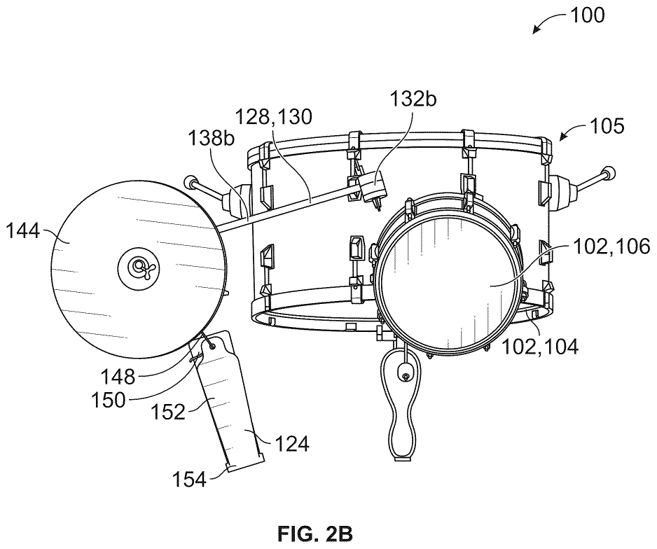

FIGS. 1A and 1B illustrate front perspective and top views, respectively, of a drum set 100, in accordance with one example aspect of the present disclosure. Example aspects of the drum set 100 can comprise various drums 102 and cymbals 108. In the example aspects of FIGS. 1A-2B, the drum set 100 can comprise a bass drum 104, a tom drum 106 (also known as a tom-tom), and a hi-hat 110. The bass drum 104 and the tom drum 106 can together define a drum assembly 105 of the drum set 100. Such bass drums 104 and tom drums 106 are well-known in the art. The drum set 100 can comprise more or fewer drums 102, cymbals 108, and/or other percussion instruments in other aspects.

The hi-hat 110 can be a string-drawn hi-hat 120, as will be described in further detail throughout the present disclosure. The string-drawn hi-hat 120 can eliminate the need for a hi-hat floor stand, as it can be mounted off of a kick drum (such as bass drum 104) or another part of the drum set 100. According to example aspects, the string-drawn hi-hat 120 can comprise a hi-hat cymbal assembly 122, a foot pedal 124, and an actuator string 126 operatively connecting the cymbal assembly 122 to the foot pedal 124. The string-drawn hi-hat 120 can further comprise a cymbal mount 128 for mounting the cymbal assembly 122 to the drum assembly 105. For example, in the present aspect, the cymbal mount 128 can comprise a mounting arm 130 coupled to the bass drum 104 configured to cantilever the cymbal assembly 122 of the string-drawn hi-hat 120 from the drum assembly 105. The mounting arm 130 can be coupled to the bass drum 104 at or near a top of the bass drum 104. In other aspects, the cymbal mount 128 can be coupled to the drum assembly 105 at any other suitable location. In other aspects, the cymbal mount 128 may not be coupled to the drum assembly 105, and can be attached to any other suitable component of the drum set 100.

In an aspect of the present disclosure, the mounting arm 130 can comprise one or more pivot hinges 132 connecting multiple arm segments 138 as shown, for example, in FIG. 1A. In the present aspect, the mounting arm 130 can comprise a first pivot hinge 132a and a second pivot hinge 132b. The first pivot hinge 132a can pivotably connect a first arm segment 138a and a second arm segment 138b of the mounting arm 130. The second pivot hinge 132b can pivotably connect the second arm segment 138b and a third arm segment 138c of the mounting arm 130. The first arm segment 138a can be coupled to the cymbal assembly 122, and the third arm segment 138c can be coupled to the bass drum 104. More specifically, in the present aspect, the first arm segment 138a can be coupled to a housing 140 of the cymbal assembly 122. The pivot hinges 132 can allow a musician to selectively reposition the string-drawn hi-hat 120 relative to the drum assembly 105 as desired. Such adjustability can be desirable to musicians who prefer to locate the hi-hat 110 in a non-traditional position. In some aspects, each of the pivot hinges 132 can comprise a hinge lock 136 for locking the pivot hinges 132 in place at the desired angle.

Other aspects of the mounting arm 130 can comprise more or fewer pivot hinges 132 and/or arm segments 138. Moreover, other aspects of the cymbal mount 128 can also or alternatively comprise any other suitable adjustability feature(s) to allow for even more versatility in the positioning of the cymbal assembly 122.

FIGS. 1A and 1B illustrate the mounting arm 130 in a shortened configuration, and FIGS. 2A and 2B illustrate the mounting arm 130 in a lengthened configuration. In the shortened configuration, the first arm segment 138a of the mounting arm 130 can be pivoted upward at the first pivot hinge 132 a to orient the first arm segment 138 a at about 90° relative to the second arm segment 138b. The cymbal assembly 122 can be positioned higher and in closer proximity to the drum assembly 105 in the shortened configuration. In the lengthened configuration, the firm arm segment 138 can be pivoted downward and outward at the first pivot hinge 132a or orient the first arm segment 138a about parallel with the second arm segment 138b. The cymbal assembly 122 can be positioned lower and further from the drum assembly 105 in the lengthened configuration. In example aspects, the second arm segment 138b can further be pivoted at the second pivot hinge 132b relative to the third arm segment 138c to further reposition the cymbal assembly 122 as desired.

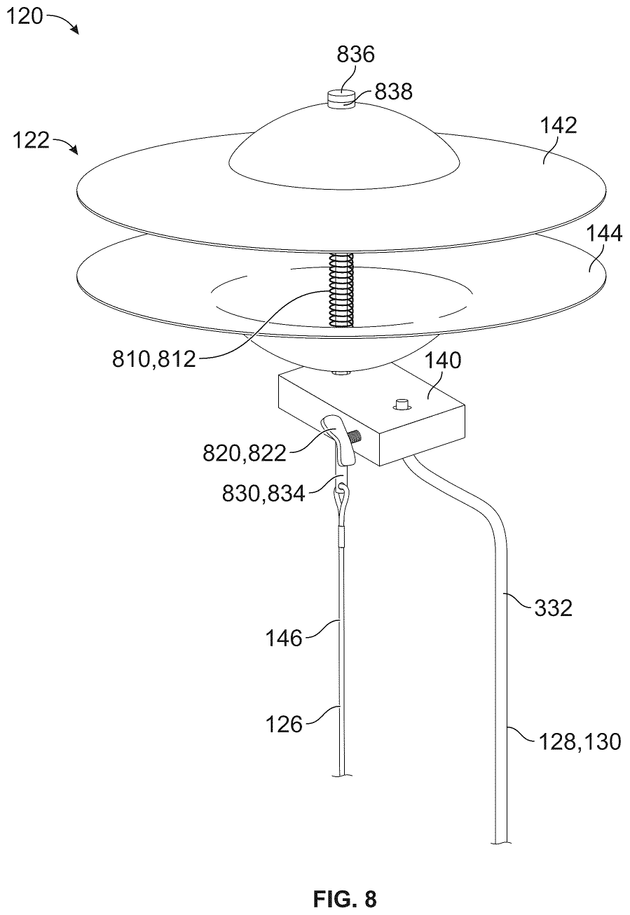

With continuing reference to FIGS. 1A-2B, the hi-hat cymbal assembly 122 can comprise an upper cymbal 142 and a lower cymbal 144 (as shown, for example, in FIG. 8). The upper cymbal 142 can be hit against the lower cymbal 144 to create a clanging sound, as will be understood by one of ordinary skill in the art. The upper cymbal 142 can be naturally biased away from the lower cymbal 144 by a cymbal spring 810 (as shown, for example, in FIG. 8) or other suitable resilient device. In example aspects, the upper cymbal 142 can be connected, either directly or indirectly, to the actuator string 126 at an upper string end 146 thereof. The upper string end 146 can engage or pass through the housing 140 of the cymbal assembly 122 in some aspects, as described in further detail below.

The actuator string 126 can further be connected to the foot pedal 124 at a lower string end 148 thereof, opposite the upper string end 146. In example aspects, the actuator string 126 can extend substantially vertically between the foot pedal 124 and the cymbal assembly 122. In some aspects, the actuator string 126 can be angled relative to vertical. Example aspects of the foot pedal 124 can comprise a base 150 configured to rest on a floor or other suitable support surface such as a raised stage or pedestal on which the drum set 100 is mounted. The foot pedal 124 can further comprise an actuator pedal 152 pivotably coupled to the base 150 by a pedal hinge 154. The lower string end 148 of the actuator string 126 can be coupled to the actuator pedal 152 (as shown, for example, in FIG. 1A). To operate the string-drawn hi-hat 120, a musician can push their foot downward on the actuator pedal 152 to pivot the actuator pedal 152 towards the base 150. The actuator string 126 connected to the actuator pedal 152 can be pulled downward and can draw the upper cymbal 142 towards the lower cymbal 144, overcoming the spring force of the cymbal spring 810. A clanging sound can be created by the upper cymbal 142 hitting the lower cymbal 144, as previously described.

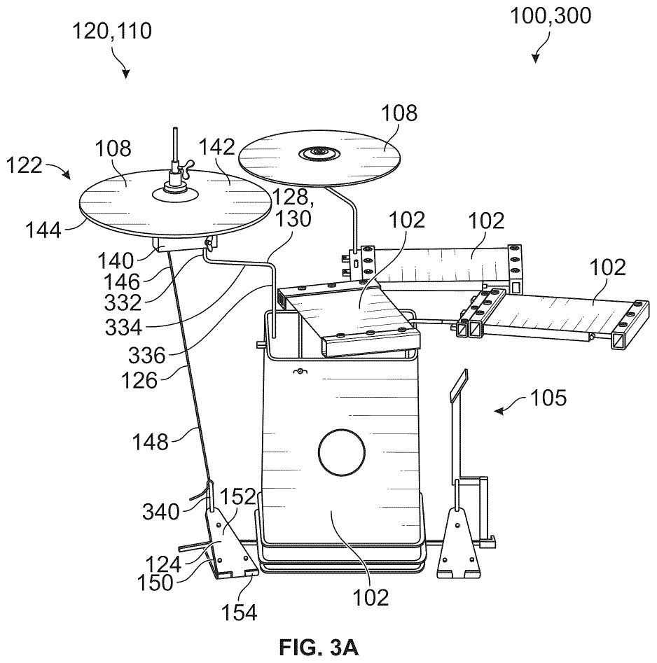

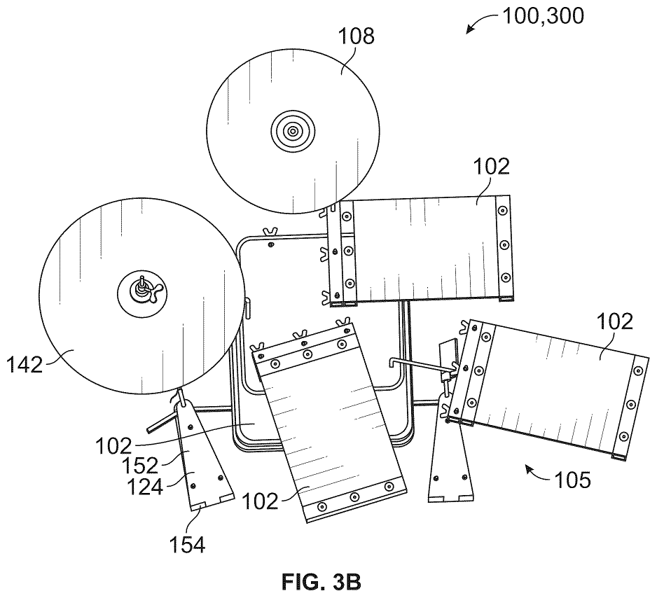

FIGS. 3A and 3B illustrate front perspective and top views, respectively, of a drum set 100 in accordance with another example aspect of the present disclosure. The drum set 100 of the present aspect can be an acoustic drum set 300. Similar to the drum set 100 of FIGS. 1A-2B, the acoustic drum set 300 can comprise a plurality of drums 102 and cymbals 108, including another example aspect of the string-drawn hi-hat 120. The string-drawn hi-hat 120 of FIGS. 3A and 3B can comprise the cymbal assembly 122, the actuator string 126, the foot pedal 124, and the cymbal mount 128. As previously described, the cymbal mount 128 can connect the cymbal assembly 122 to the drum assembly 105 to support the cymbal assembly 122 above the floor. The actuator string 126 can extend between the cymbal assembly 122 and the foot pedal 124.

The foot pedal 124 can rest on the floor (or other support surface) and can be operated by a musician to hit the upper cymbal 142 against the lower cymbal 144. In the present aspect, the lower string end 148 of the actuator string 126 can be coupled to the actuator pedal 152 by a clip fastener 340. In other aspects, the lower string end 148 can be coupled to the actuator pedal 152 by any other suitable fastener or fastening technique.

The cymbal mount 128 can comprise the mounting arm 130. In the present aspect, the mounting arm 130 can define a first vertical mount segment 332, a second vertical mount segment 336, and a horizontal mount segment 334 extending between the first and second vertical mount segments 332, 336. The first vertical mount segment 332 can extend substantially vertically downward from the housing 140 of the cymbal assembly 122. The horizontal mount segment 334 can extend substantially horizontally from the first vertical mount segment 332, opposite the housing 140, in a direction generally towards the drum assembly 105. The second vertical mount segment 336 can extend substantially vertically downward from the horizontal mount segment 334, opposite the first vertical mount segment 332, and can be connected to the drum assembly 105. More specifically, in the present aspect, the second vertical mount segment 336 can be connected to the bass drum 104.

In some aspects, the housing 140 of the cymbal assembly 122 can be pivotably coupled to the first vertical mount segment 332, and can pivot about a substantially vertical axis to reposition the cymbal assembly 122 relative to the drum assembly 105 as desired. Moreover, in some aspects, the second vertical mount segment 336 can be pivotably coupled to the drum assembly 105, and can pivot about a substantially vertical axis to further reposition the cymbal assembly 122 relative to the drum assembly 105 as desired. Other aspects of the cymbal mount 128 can also or alternatively comprise one or more of the pivot hinges 132 (as shown, for example, in FIG. 1A) or any other suitable adjustability feature(s) to allow for even more versatility in the positioning of the cymbal assembly 122.

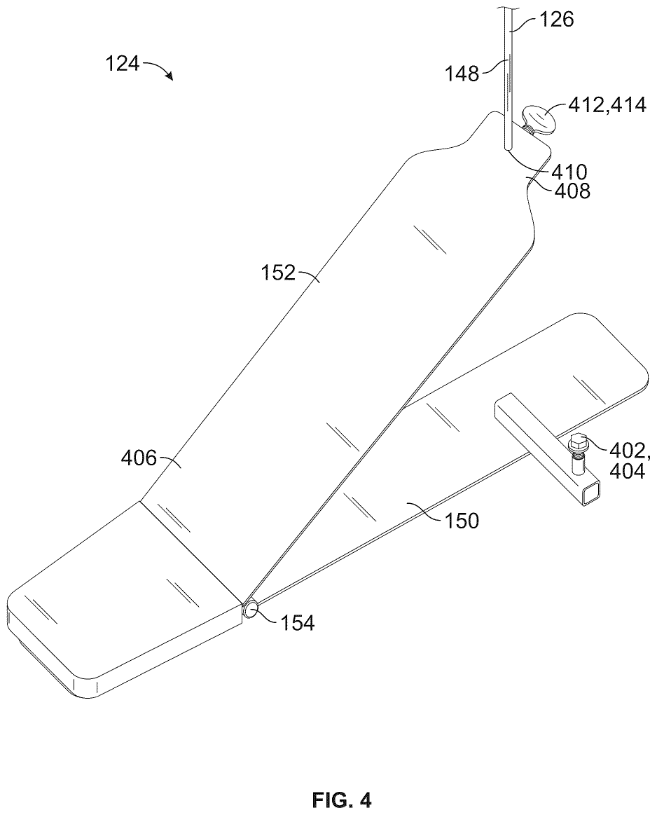

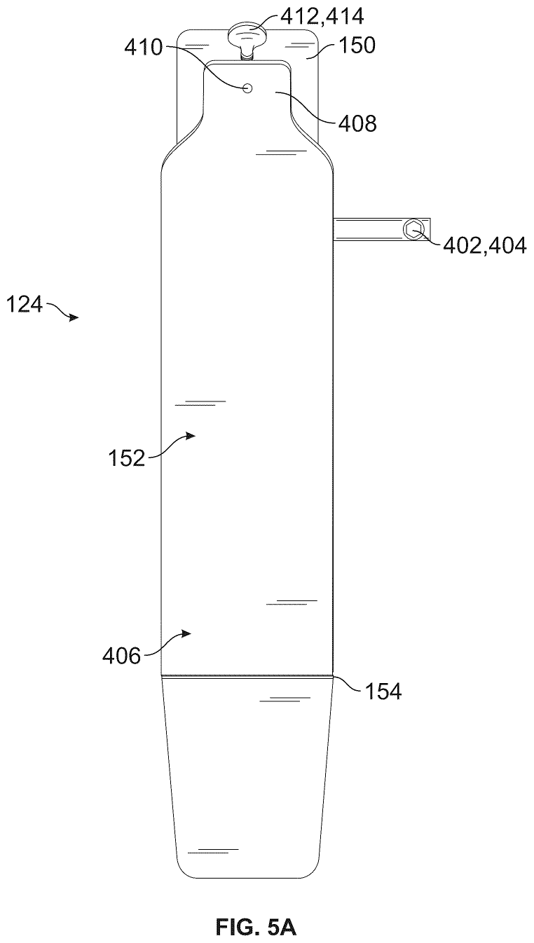

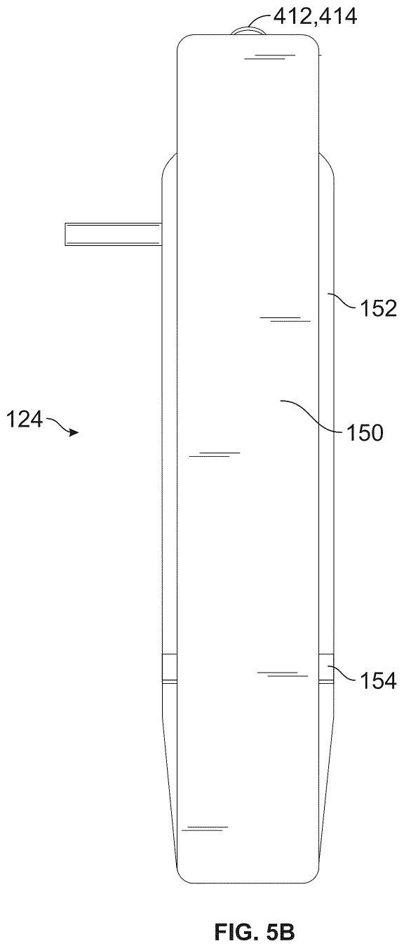

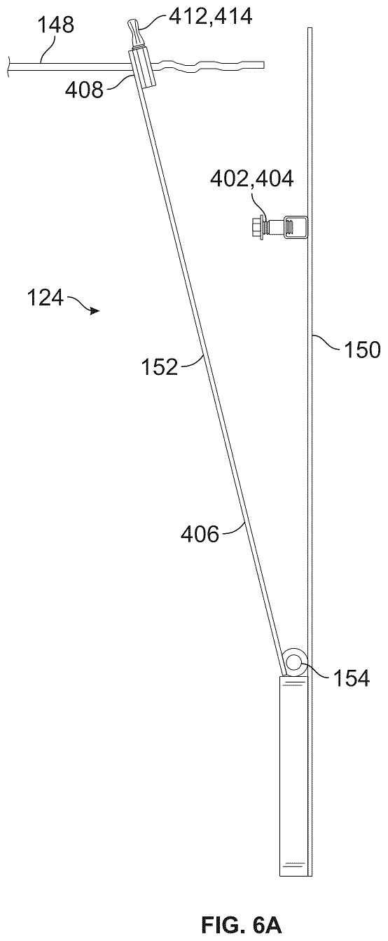

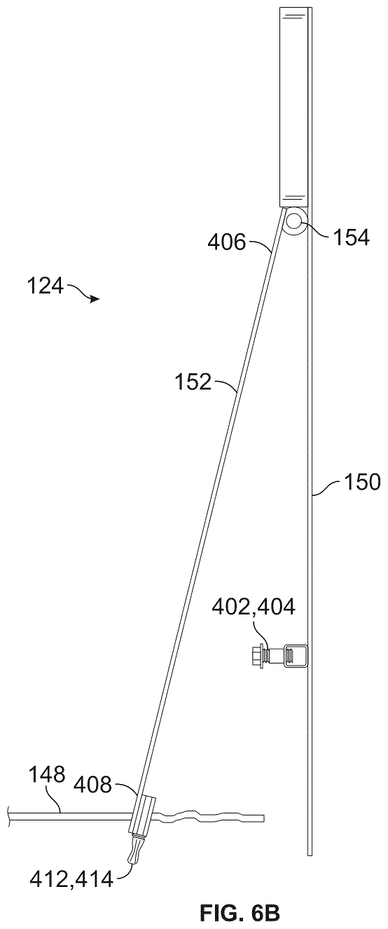

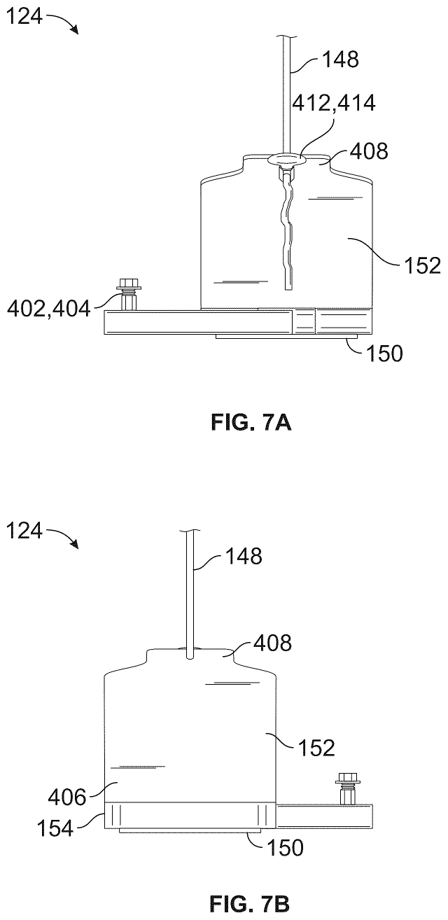

FIGS. 4-7B illustrate an example aspect of the foot pedal 124. The foot pedal 124 can comprise the base 150 and the actuator pedal 152. The actuator pedal 152 can be pivotably connected to the base 150 by the pedal hinge 154. The base 150 can be configured to rest on the floor or other support surface, and the actuator pedal 152 can be cantilevered upward from the base 150. In some aspects, the foot pedal 124 can comprise a floor fastener 402 attached to the base 150 configured to secure the foot pedal 124 to the floor. The floor fastener 402 can be a floor screw 404, for example and without limitation, or any other suitable fastener or fastening technique known in the art.

The actuator pedal 152 can define a first pedal end 406 connected to the pedal hinge 154 and a second pedal end 408 distal to the first pedal end 406. The lower string end 148 of the actuator string 126 can be connected to the actuator pedal 152 proximate to the second pedal end 408. The actuator pedal 152 can be biased to a raised position, as shown, by the cymbal spring 810 (shown, for example, in FIG. 8). In the present aspect, the lower string end 148 can extend through a pedal opening 410 formed through the actuator pedal 152. The foot pedal 124 can further comprise a string fastener 412, such as a string screw 414 for example and without limitation, configured to secure the actuator string 126 to the actuator pedal 152. In other aspects, the lower string end 148 can be attached to the actuator pedal 152 by any other suitable fastener or fastening technique known in the art.

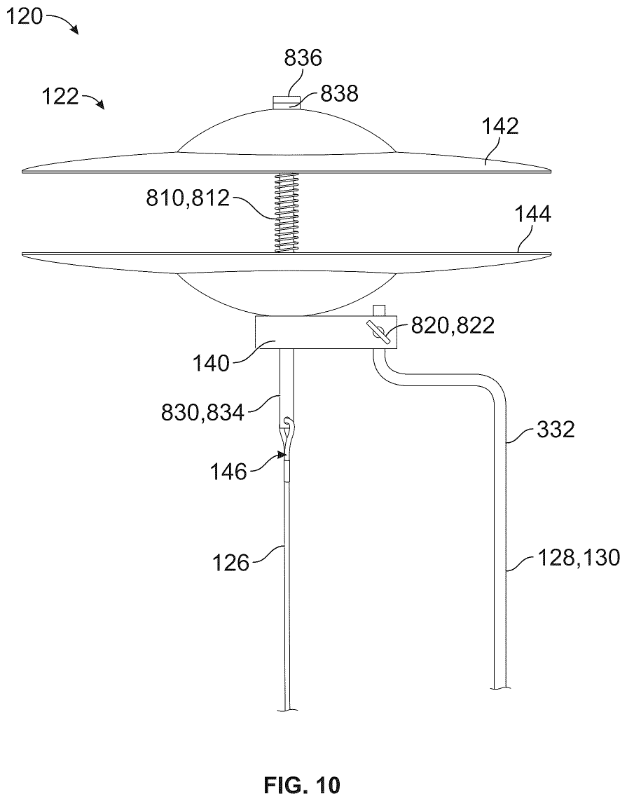

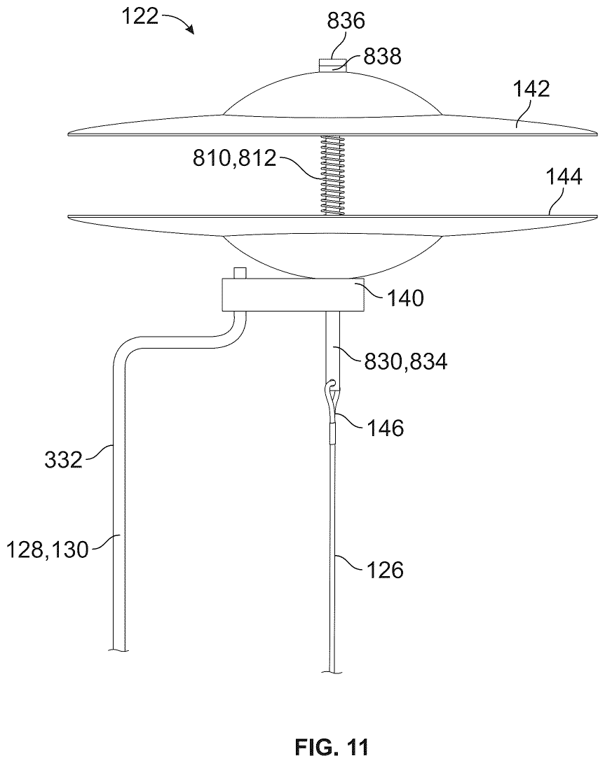

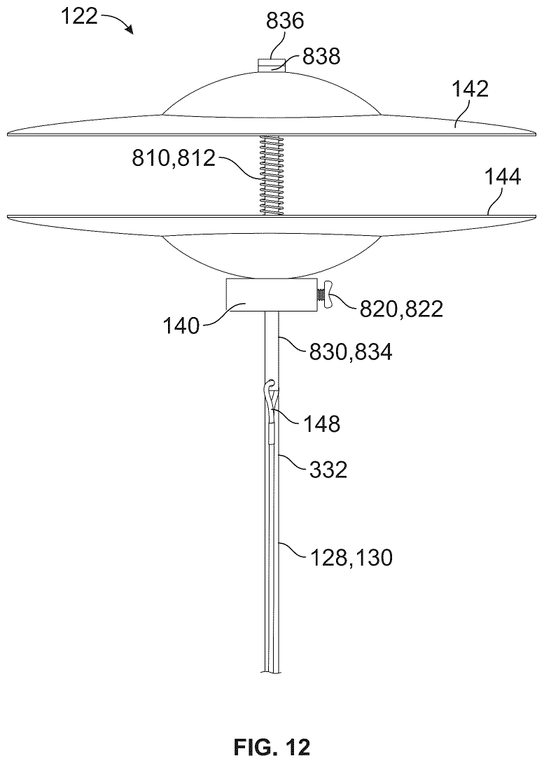

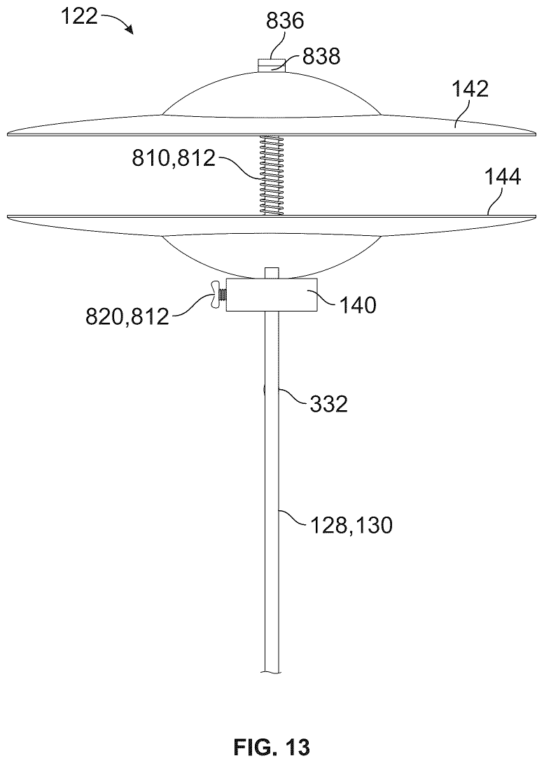

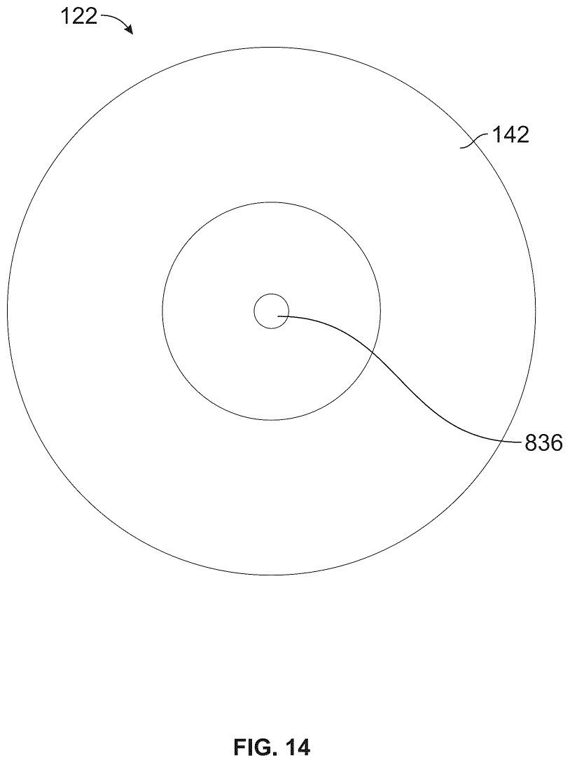

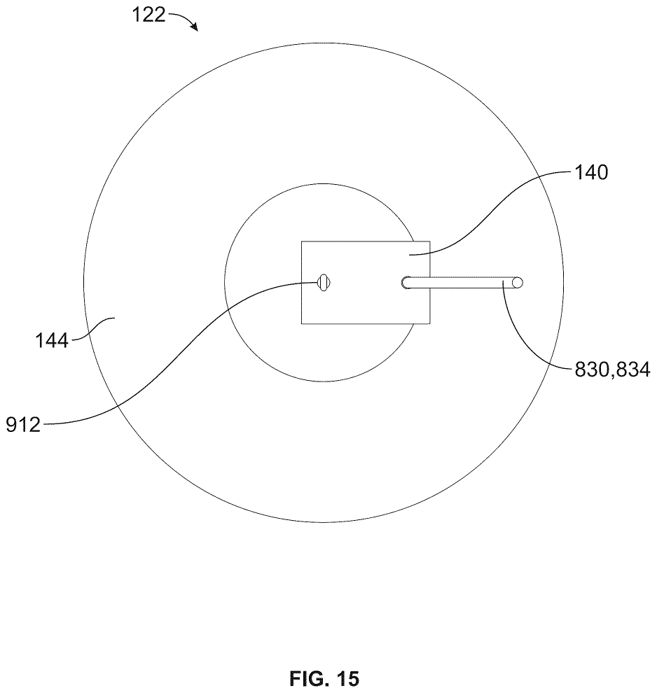

FIGS. 8-15 illustrate the cymbal assembly 122 according to one example aspect of the present disclosure. The cymbal assembly 122 of the present aspect can be the same as or similar to the cymbal assembly 122 shown in FIGS. 3A and 3B. The cymbal assembly 122 can comprise the upper cymbal 142, the lower cymbal 144, and the housing 140. As shown, the housing 140 can be coupled to the mounting arm 130 of the cymbal mount 128. In some aspects, the cymbal assembly 122 can be configured to pivot about the first vertical mount segment 332 of the mounting arm 130. Additionally, in some aspects, the cymbal assembly 122 can comprise a mount fastener 820, such as a mount wing screw 822 for example and without limitation, for securing the housing 140 to the cymbal mount 128.

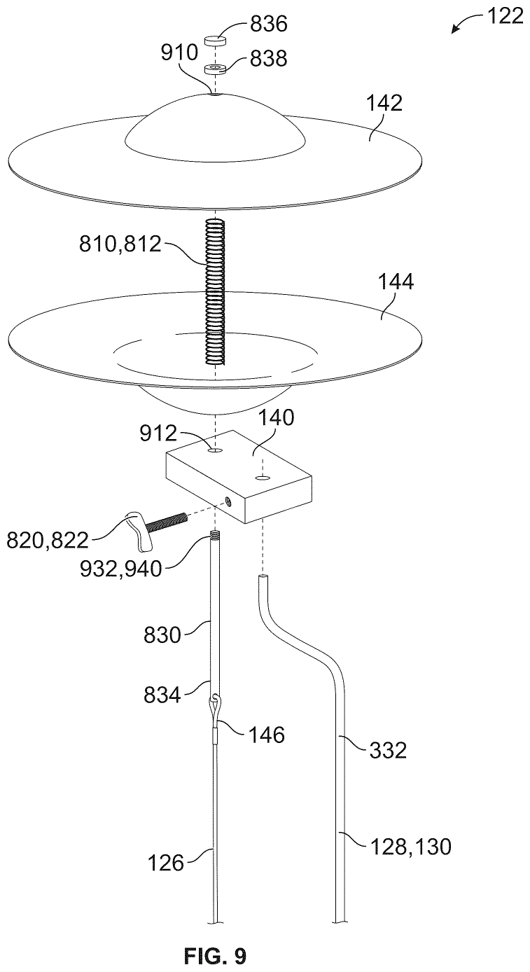

According to example aspects, the cymbal assembly 122 can further comprise a cymbal rod 830. The cymbal rod 830 can define an upper rod end 932 (shown, for example, in FIG. 9) and a lower rod end 834 opposite the upper rod end 932. The upper string end 146 of the actuator string 126 can be attached to the cymbal rod 830 at the lower rod end 834. The cymbal rod 830 can extend substantially vertically through each of the housing 140 and the lower cymbal 144. The lower cymbal 144 can be mounted on the cymbal rod 830 between the housing 140 and the upper cymbal 142, and in some cases, the lower cymbal 144 can rest on and/or be attached to the housing 140. As shown in FIG. 9, each of the upper cymbal 142 and the lower cymbal 144 can define a cymbal opening 910 formed centrally therethrough, and the housing 140 can define a housing opening 912 formed therethrough. The cymbal rod 830 can extend through the housing opening 912 and each of the cymbal openings 910.

A rod cap 836 can be secured to the upper rod end 932 of the cymbal rod 830. In the present aspect, the rod cap 836 can be substantially disc-shaped. The rod cap 836 can be sized to prohibit passage thereof through the cymbal opening 910 of the upper cymbal 142, thereby retaining the cymbal rod 830 in engagement with the housing 140 and the upper and lower cymbals 142, 144. In some aspects, the upper rod end 932 of the cymbal rod 830 can define external threading 940 (as shown, for example, in FIG. 9) configured to engage internal threading in the rod cap 836. In other aspects, the rod cap 836 can be coupled to the cymbal rod 830 by any other suitable fastener or fastening technique. Furthermore, in some aspects, a felt washer 838 can be mounted on the upper rod end 932 of the cymbal rod 830 between the upper cymbal 142 and the rod cap 836.

The cymbal assembly 122 can further comprise the cymbal spring 810, which can be a compression spring 812 in the present aspect. In other aspects, the cymbal spring 810 can be any other suitable spring or resilient device. The cymbal spring 810 can be mounted on the cymbal rod 830 (that is, the cymbal rod 830 can extend through a central spring channel of the cymbal spring 810) between the upper cymbal 142 and the lower cymbal 144. As such, the upper cymbal 142 can be arranged between the cymbal spring 810 and the felt washer 838. In some aspects, an additional felt washer 838 may be mounted on the cymbal rod 830 between the cymbal spring 810 and the upper cymbal 142, such that the upper cymbal 142 is arranged between a pair of the felt washers 838. Moreover, in some aspects, additional felt washers 838 may be mounted on the cymbal rod 830 at either or both sides of the lower cymbal 144. The cymbal spring 810 can bias the upper cymbal 142 away from the lower cymbal 144, until a suitable force is applied to overcome the spring force of the cymbal spring 810.

When the actuator pedal 152 is operated (i.e., pressed towards the base 150 by a musician's foot) to pull the actuator string 126 downward, the cymbal rod 830 can be pulled downward by the actuator string 126. The rod cap 836 connected to the upper rod end 932 of the cymbal rod 830 can push the upper cymbal 142 downward against the cymbal spring 810, compressing the cymbal spring 810 between the upper cymbal 142 and the lower cymbal 144. If the upper cymbal 142 is drawn far enough downwards (i.e., if the actuator pedal 152 is sufficiently pushed towards the base 150 by the musician's foot), the upper cymbal 142 can hit the lower cymbal 144 to produce the clanging sound.

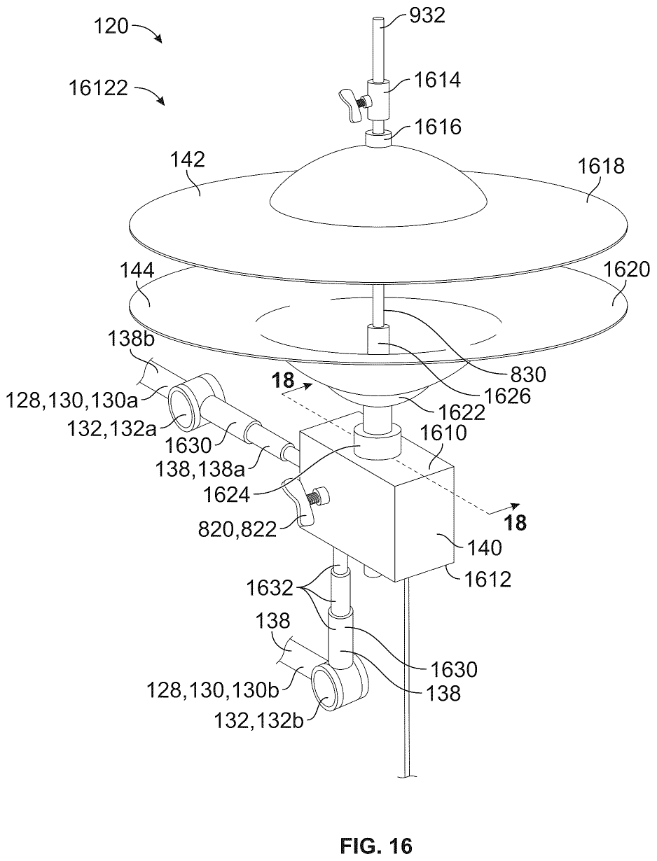

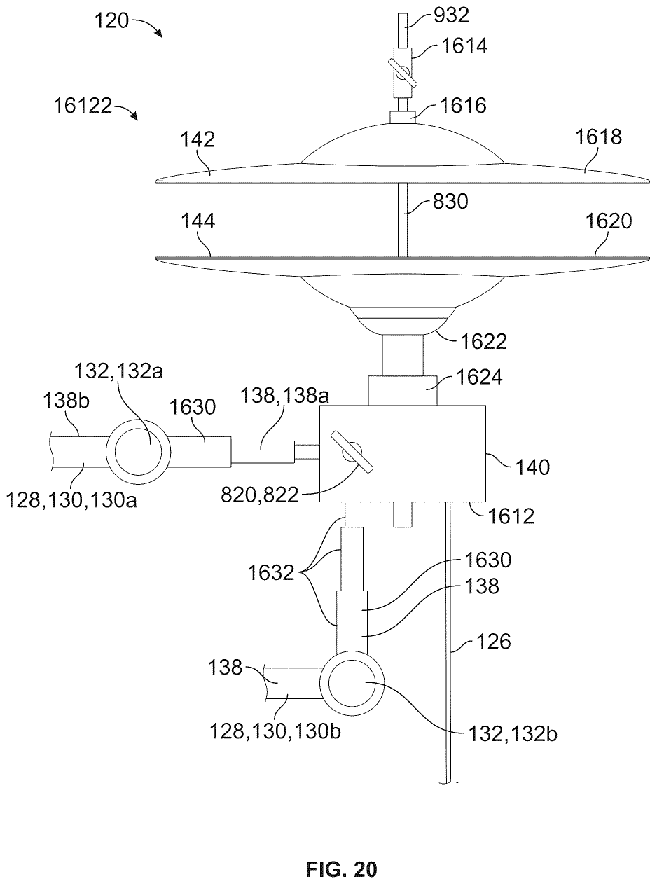

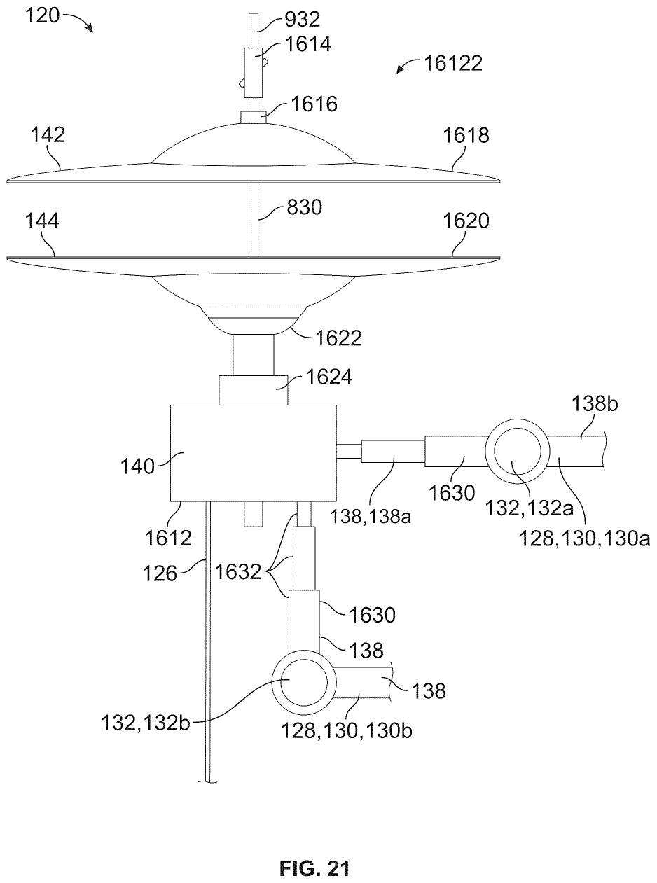

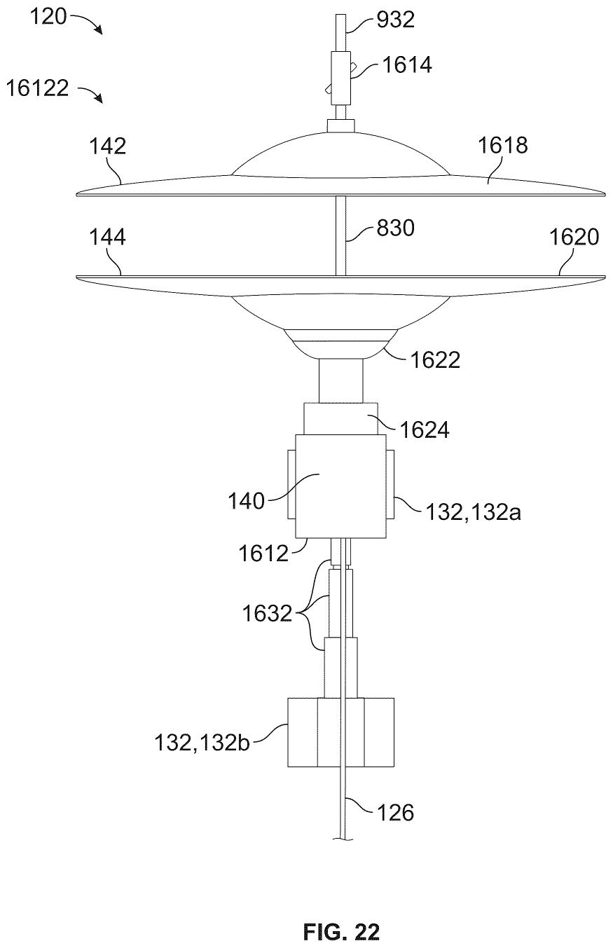

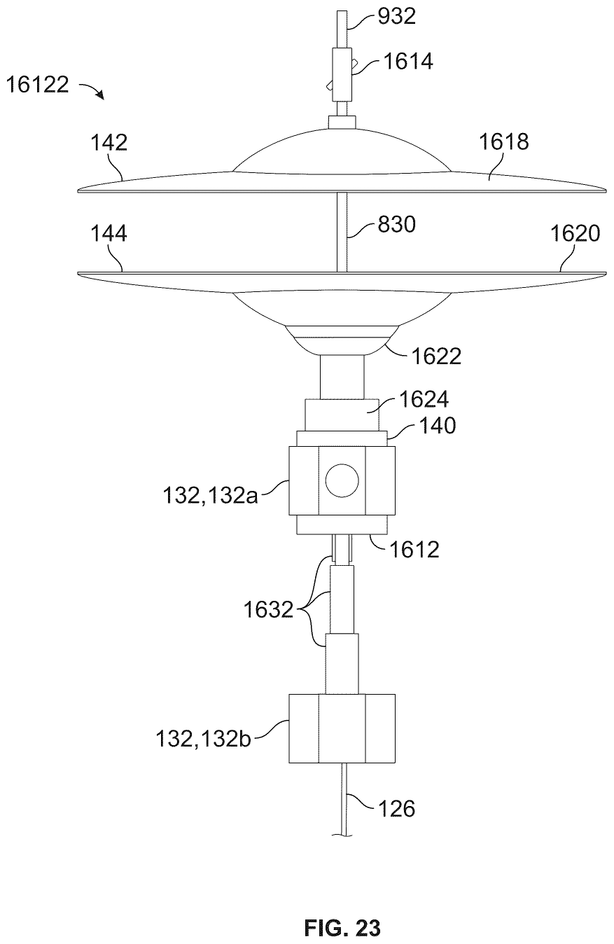

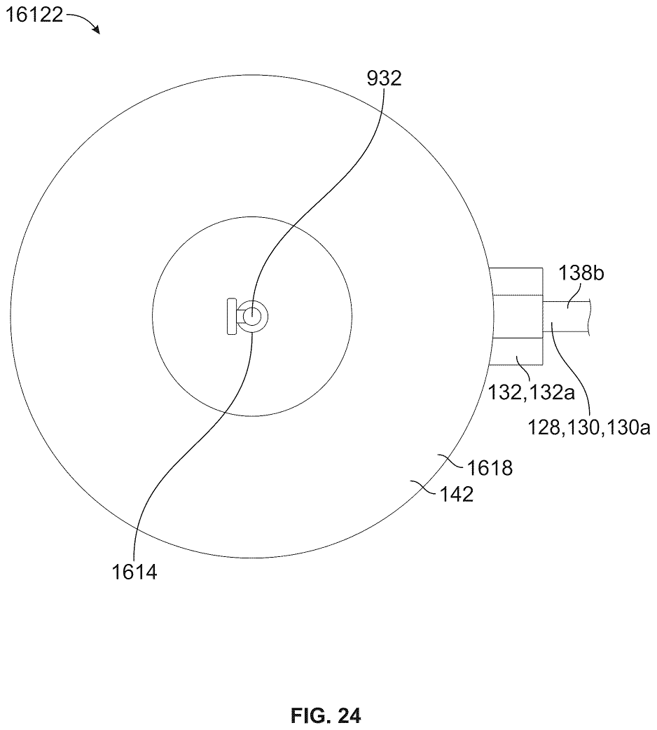

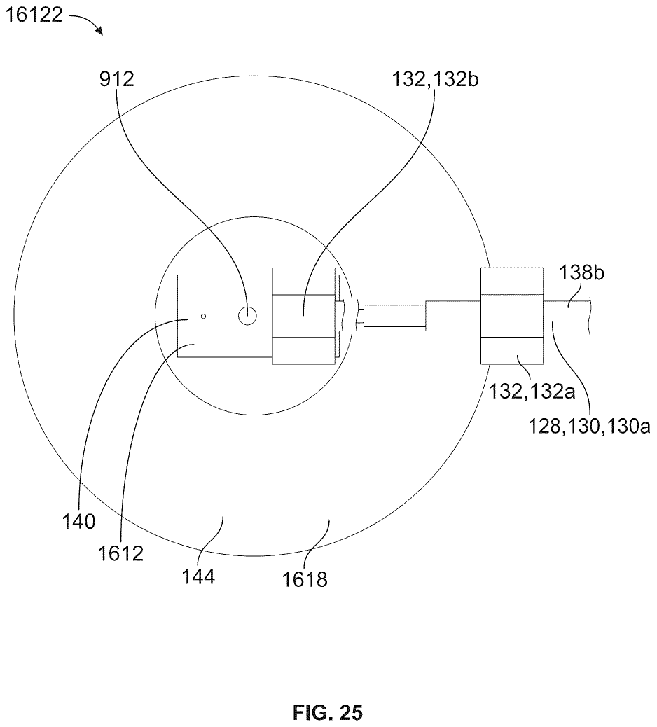

FIGS. 16-25 illustrate the cymbal assembly 122, 16122 according to another example aspect of the present disclosure. The cymbal assembly 122, 16122 of the present aspect can be similar to the cymbal assembly 122 shown in FIGS. 1A-2B. The cymbal assembly 122, 16122 can comprise the upper cymbal 142, the lower cymbal 144, and the housing 140. As shown, the housing 140 can be coupled to the mounting arm 130 of the cymbal mount 128, which can be a first mounting arm 130a in the present aspect. The cymbal mount 128 of the string-drawn hi-hat 120 can further comprise a second mounting arm 130b for further supporting the cymbal assembly 122, 16122 above the floor. The cymbal assembly 122, 16122 can be mounted on the first mounting arm 130a at a 180 degree angle relative to the bottom housing end 1612 as well as on the second mounting arm 130b at a 90 degree angle relative to the bottom housing end 1612. Each of the first mounting arm 130a and the second mounting arm 130b can be coupled to the housing 140 by one or more of the mount fasteners 820, such as a mount wing screw 822, for example and without limitation.

Similar to the first mounting arm 130a, the second mounting arm 130b can comprise various arm segments 138 and pivot hinges 132 to allow for repositioning the cymbal assembly 122, 16122 relative to the drum assembly 105. Moreover, in some aspects, one or more of the arm segments 138 can be a telescoping arm segment 1630 comprising two or more telescoping sections 1632. The telescoping arm segments 1630 can be selectively adjustable in length to even further improve the ability to reposition the string-drawn hi-hat 120 as desired by the musician.

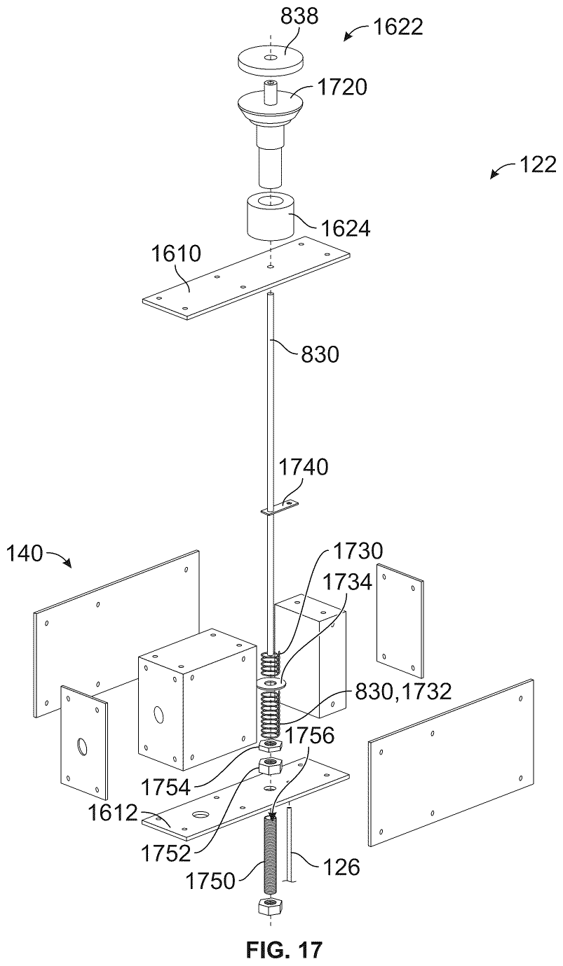

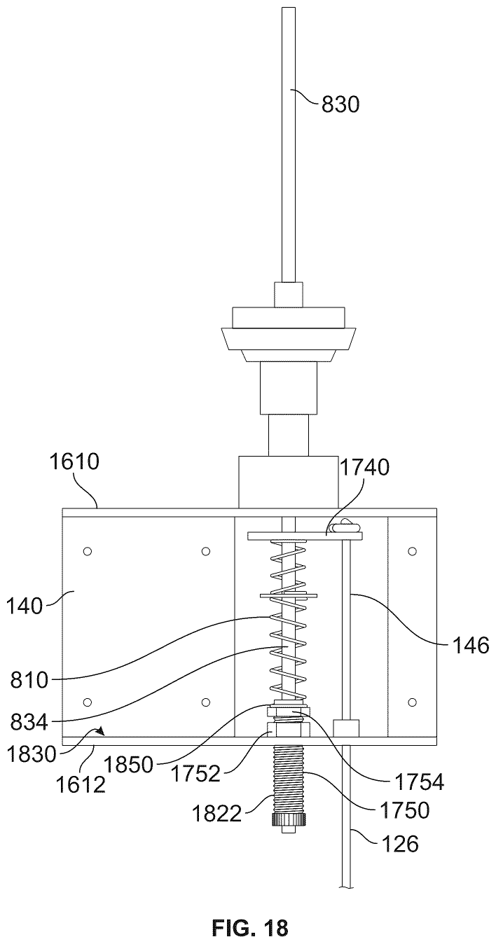

The cymbal rod 830 can extend through the upper cymbal 142 and the lower cymbal 144 as previously described. The lower rod end 834 of the cymbal rod 830 can extend into the housing 140 at a top housing end 1610 thereof. The upper cymbal 142 can be biased away from the lower cymbal 144 by the cymbal spring 810 (as shown, for example, in FIG. 17), which can be mounted on the cymbal rod 830 within the housing 140 at or near the lower rod end 834. The upper string end 146 (as shown, for example, in FIG. 18) of the actuator string 126 can extend into the housing 140 at a bottom housing end 1612. The upper string end 146 of the actuator string 126 can be indirectly coupled to the lower rod end 834 of the cymbal rod 830 within the housing 140 as described in further detail below with respect to FIG. 18.

According to example aspects, a cymbal clutch 1614 can be mounted on the cymbal rod 830 (that is, the cymbal rod 830 can extend through a central clutch channel of the cymbal clutch 1614) proximate to the upper rod end 932. Such cymbal clutches 1614 are well known in the art and will be understood by one of ordinary skill. Additionally, a first upper retaining nut 1616 can be threadedly mounted on the cymbal rod 830 between the upper cymbal 142 and the cymbal clutch 1614. The first upper retaining nut 1616 can confront an outer cymbal surface 1618 of the upper cymbal 142. In some aspects, one of the felt washers 838 can be arranged between the first upper retaining nut 1616 and the outer cymbal surface 1618 of the upper cymbal 142. A second upper retaining nut (not shown) can be mounted on the cymbal rod 830 between the upper cymbal 142 and the lower cymbal 144 and can confront an inner cymbal surface 1620 of the upper cymbal 142 to secure the upper cymbal 142 in position on the cymbal rod 830 between the first upper retaining nut 1616 and the second upper retaining nut. In some aspects, another felt washer 838 can be arranged between the second upper retaining nut and the inner cymbal surface 1620 of the upper cymbal 142. In some aspects, the second upper retaining nut can be substantially the same as or similar to the illustrated first upper retaining nut 1616.

A cymbal seat 1622 can be slidably mounted on the cymbal rod 830 between the housing 140 and the lower cymbal 144 and can confront the outer cymbal surface 1618 of the lower cymbal 144. Some aspects can further comprise a collar 1624 mounted on the cymbal rod 830 between the housing 140 and the cymbal seat 1622 configured to hold the cymbal seat 1622 firmly in place. The collar 1624 can be metal or plastic is some aspects, for example and without limitation. In some aspects, a top portion 1626 of the cymbal seat 1622 can extend upward through the lower cymbal 144, as shown, towards the upper cymbal 142. The cymbal seat 1622 can support the lower cymbal 144 over the housing 140. Referring to FIG. 17, example aspects of the cymbal seat 1622 can comprise a support cup 1720 and another felt washer 838. The felt washer 838 of the cymbal seat 1622 can be arranged between the support cup 1720 and the outer cymbal surface 1618 of the lower cymbal 144.

With continuing reference to FIG. 17, example aspects of the cymbal spring 810 can comprise an upper spring segment 1730 and a lower spring segment 1732. In some aspects, a spring washer 1734 can be mounted on the cymbal rod 830 between the upper spring segment 1730 and the lower spring segment 1732. Moreover, the cymbal assembly 122, 16122 of the present aspect can further comprise a linkage plate 1740, a rod sleeve 1750, a sleeve retaining nut 1752, and a stop nut 1754, as described in further detail below with respect to FIG. 18. The rod sleeve 1750 can define a sleeve channel 1756 therethrough.

FIG. 18 illustrates a cross-sectional view of the housing 140 taken along line 18-18 in FIG. 16. As shown, the upper string end 146 of the actuator string 126 can extend into the housing 140 at the bottom housing end 1612. The lower rod end 834 of the cymbal rod 830 can extend into the housing 140 at the top housing end 1610 thereof. The upper string end 146 can be oriented substantially parallel to the lower rod end 834. According to example aspects, the linkage plate 1740 can extend laterally between and can be attached to each of the upper string end 146 and the lower rod end 834 to indirectly couple the cymbal rod 830 to the actuator string 126.

The rod sleeve 1750 can extend through and can be fixedly mounted to the bottom housing end 1612 of the housing 140. An outer sleeve surface 1822 of the rod sleeve 1750 can be threaded in example aspects, and the sleeve retaining nut 1752 can be threadedly mounted on the rod sleeve 1750 within the housing 140. In some aspects, the sleeve retaining nut 1752 can be affixed to an inner housing surface 1830 of the bottom housing end 1612. The rod sleeve 1750 can define the sleeve channel 1756 (as shown in FIG. 17) extending substantially vertically therethrough. The rod sleeve 1750 can be vertically aligned with the cymbal rod 830, and the lower rod end 834 of the cymbal rod 830 can slidably engage the sleeve channel 1756 of the rod sleeve 1750.

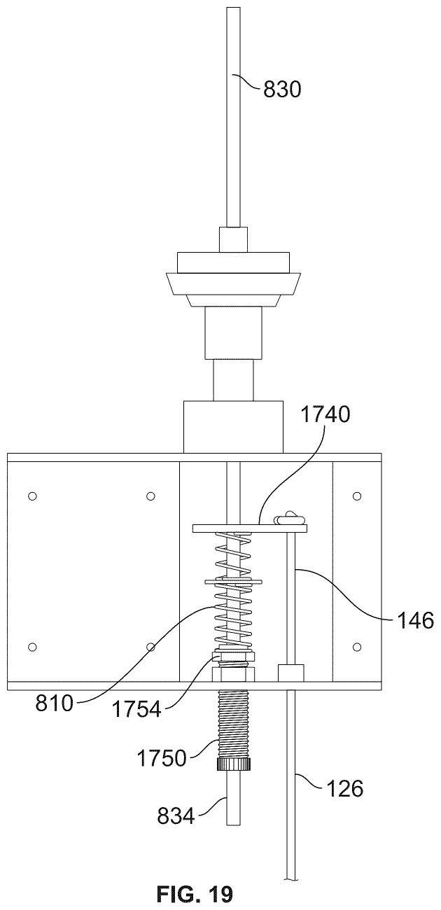

The stop nut 1754 can be threadedly mounted on the rod sleeve 1750 at an upper sleeve end 1850 thereof within the housing 140. The cymbal spring 810 can be mounted on the rod sleeve 1750 between the stop nut 1754 and the linkage plate 1740. In the present aspect, when the actuator string 126 is pulled downward by operation of the foot pedal 124 (as shown, for example, in FIG. 1A), the linkage plate 1740 connected to the actuator string 126 can also be drawn downward within the housing 140. The linkage plate 1740 can be fixedly coupled to the cymbal rod 830, such that the linkage plate 1740 can simultaneously pull the cymbal rod 830 downward, sliding the lower rod end 834 of the cymbal rod 830 within the rod sleeve 1750 and compressing the cymbal spring 810 between the linkage plate 1740 and the stop nut 1754. As previously described, the downward movement of the cymbal rod 830 can draw the upper cymbal 142 downwards to hit the upper cymbal 142 against the lower cymbal 144. FIG. 19 illustrates the lower rod end 834 of the cymbal rod 830 slid downward through the rod sleeve 1750 and the cymbal spring 810 compressed between the linkage plate 1740 and the stop nut 1754.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more particular embodiments or that one or more particular embodiments necessarily include logic for deciding, with or without user input or prompting, whether these features, elements, and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

What is claimed:

1. A hi-hat comprising:
a cymbal assembly comprising an upper cymbal and a lower cymbal, the upper cymbal biased away from the lower cymbal;
a foot pedal configured to rest on a support surface;
an actuator string extending between the cymbal assembly and the foot pedal, wherein the foot pedal is operable to pull the actuator string towards the support surface to hit the upper cymbal against the lower cymbal;
at least one cymbal mount configured to be coupled to a drum assembly and support a housing above the support surface, wherein the housing supports the cymbal assembly; and
a plurality of apertures formed in the housing, wherein each of the plurality of apertures is configured to either accept the actuator string or engage with the cymbal mount.

2. The hi-hat of claim 1, wherein the cymbal mount comprises one or more vertical mount segments and one or more horizontal mount segments.

3. The hi-hat of claim 2, wherein at least one vertical mount segment is connected to at least one horizontal mount segment by a pivot hinge.

4. The hi-hat of claim 3, wherein the pivot hinge comprises a hinge lock configured to lock the pivot hinge in place at a desired angle.

5. The hi-hat of claim 1, wherein the upper cymbal is directly connected to the actuator string.

6. The hi-hat of claim 1, wherein the upper cymbal is directly connected to a cymbal rod and the cymbal rod is directly connected to the actuator string.

7. The hi-hat of claim 1, wherein the upper cymbal is directly connected to a cymbal rod and the cymbal rod is indirectly connected to the actuator string.

8. The hi-hat of claim 7, wherein the cymbal rod is indirectly connected to the actuator string by a linkage plate.

9. The hi-hat of claim 7, wherein the housing comprises a rod sleeve configured to allow the cymbal rod to pass through a bottom end of the housing when pulled by the actuator string.

10. The hi-hat of claim 9, wherein the cymbal rod extends through a spring in the housing between a bottom end of the linkage plate and a top end of the rod sleeve.

11. A drum set comprising:
a drum assembly;
a hi-hat comprising:
a cymbal assembly comprising an upper cymbal and a lower cymbal, the upper cymbal biased away from the lower cymbal;
a foot pedal configured to rest on a support surface;
an actuator string extending between the cymbal assembly and the foot pedal, wherein the foot pedal is operable to pull the actuator string towards the support surface to hit the upper cymbal against the lower cymbal;
at least one cymbal mount coupled to the drum assembly and supporting a housing above the support surface, wherein the housing supports the cymbal assembly; and
a plurality of apertures formed in the housing, wherein each of the plurality of apertures is configured to either accept the actuator string or engage with the cymbal mount.

12. The drum set of claim 11, wherein the cymbal mount comprises one or more vertical mount segments and one or more horizontal mount segments.

13. The drum set of claim 12, wherein at least one vertical mount segment is connected to at least one horizontal mount segment by a pivot hinge.

14. The drum set of claim 13, wherein the pivot hinge comprises a hinge lock configured to lock the pivot hinge in place at a desired angle.

15. The drum set of claim 11, wherein the upper cymbal is directly connected to the actuator string.

16. The drum set of claim 11, wherein the upper cymbal is directly connected to a cymbal rod and the cymbal rod is directly connected to the actuator string.

17. The drum set of claim 11, wherein the upper cymbal is directly connected to a cymbal rod and the cymbal rod is indirectly connected to the actuator string.

18. The drum set of claim 17, wherein the cymbal rod is indirectly connected to the actuator string by a linkage plate.

19. The drum set of claim 17, wherein the housing comprises a rod sleeve configured to allow the cymbal rod to pass through a bottom end of the housing when pulled by the actuator string.

20. The drum set of claim 19, wherein the cymbal rod extends through a spring in the housing between a bottom end of the linkage plate and a top end of the rod sleeve.
